(19) United States
(12) Patent Application Publication
(10) Pub. No.: US 2020/0229413 A1
(43) Pub. Date: Jul. 23, 2020

(54) FISH HOOK THREADING ACCESSORY

(71) Applicant: Zachary Paul Snopkowski, Southbury, CT (US)

(72) Inventor: Zachary Paul Snopkowski, Southbury, CT (US)

(21) Appl. No.: 16/841,649

(22) Filed: Apr. 6, 2020

Related U.S. Application Data
(63) Continuation-in-part of application No. 15/383,617, filed on Dec. 19, 2016, now Pat. No. 10,609,912.
(60) Provisional application No. 62/831,847, filed on Apr. 10, 2019.
(60) Provisional application No. 62/368,519, filed on Jul. 29, 2016.

(51) Int. Cl. A01K 87/00; A01K 91/04

(52) U.S. Cl. CPC A01K 87/007; A01K 91/04

(57) ABSTRACT

A fish hook holding device includes a housing having a plurality of openings for insertion of a fishing hook and a plurality of first surfaces each surface disposed in the corresponding opening and a plurality of second surfaces substantially perpendicular to the corresponding first surface. The device includes a spring having a plurality of spring segments adjacent the corresponding first surface, each spring segment urged against the corresponding first surface wherein a point end of a fishing hook may be inserted into the opening and secured between the corresponding spring segment and the housing first surface. Upon insertion of a fish hook into a housing opening, a barb on the fish hook point engages the corresponding second surface, securing the hook in the opening. The hook may be removed by urging the hook toward the housing and rotated to disengage the barb from the second surface.

### BACKGROUND OF THE INVENTION

### 1. Field of the Invention

The present invention is directed to a fish hook holding device which is attachable to a fishing pole or to a fishing pole accessory and aids in holding one or more fishing hooks securely.

### 2. Description of Related Art

Threading fishing line through the eye of a fish hook and tying the fishing line in a desired manner is generally done by hand. Often the fishing line must be re-tied or the fish hook must be changed during fishing or inclement weather conditions. There are devices that clip to the fish hook to help a user tie a fishing line to the fish hook, but there exists a need in the art for a more convenient and safe way to hold the fish hook and direct the fishing line.

When a fishing line no longer has tension on it (i.e. if the hook or bait fell off after casting), tension must be applied to the line, usually with the fisherman's finger, in order to prevent tangling and knotting in the reel of the rod as the line is reeled in. The device of the present invention and its method of use allow quick and easy tension/release of the line, while being mounted to the rod and always being outside the natural movement of the fishing line as it passes through the casting guides on the pole.

### SUMMARY OF THE INVENTION

Bearing in mind the problems and deficiencies of the prior art, it is therefore an object of the present invention to provide a fishing accessory allows for a convenient and safe way to hold the fish hook.

It is another object of the present invention to provide a device attachable to a fishing pole which aid in directing and guiding the fishing line.

It is yet another object of the present invention to provide a fishing accessory that prevents tangling of a fishing line.

It is another object of the present invention to provide a fishing accessory which can secure a fishing line of various diameters.

A further object of the invention is to provide a fishing accessory which magnetically secures fishing hooks to the accessory.

It is yet another object of the present invention to provide to provide a fishing accessory for holding a fishing hook while threading the fishing line through the eye of the hook.

It is still another object of the present invention to provide a fishing accessory which allows easy threading of a fishing line through the fishing hook eyelet.

It is another object of the present invention to provide a fishing accessory for safely holding and storing a plurality of fish hooks on a fishing pole.

Still other objects and advantages of the invention will in part be obvious and will in part be apparent from the specification.

The above and other objects, which will be apparent to those skilled in the art, are achieved in the present invention which is directed to a fish hook threading device including a housing attached to a fishing pole. The housing has a threader gap with one edge formed by a first hook groove. The housing also has a first shoulder near the first hook groove facing away from the first hook groove. A threader tip extends between a second shoulder near a first end to a handle near a second end. The second shoulder faces away from the first end, towards a second hook groove, between the first end and the second end facing towards the housing. A biasing member is retained between the first shoulder and the second shoulder. A sheath attaches to the housing, covering the threader gap of the housing. The biasing member acts against the first shoulder and the second shoulder to retain the threader tip in a closed state. A user exerts a force on the handle of the threader tip to move the first hook groove relative to the second hook groove. A force generated by the biasing member is sufficient to retain the hook between the first hook groove and the second hook groove when the threader tip is in the closed state. The force the user exerts may be perpendicular to a fishing line placed therein. The threader tip may include one or more grooves forming an anvil for retaining a hook and/or for directing a fishing line. The one or more grooves may include a shank holder that retains a shank of a fishing hook when the threader tip is in the closed state. The one or more grooves may include an exit groove that accommodates a fishing line that is threaded through a fishing hook retained by the threader tip. The one or more grooves may include a threading groove that accommodates an end of a fishing line and directs the end of the fishing line through an eye of a fishing hook retained by the threader tip. The threading groove may be frustoconical in shape.

Another aspect of the present invention is directed a fish hook holding device mountable to a fishing pole. The holding device comprises a housing having an opening for insertion of a first end of a fishing hook and a first surface disposed in the opening and a second surface substantially perpendicular to the first surface. The device includes a spring having a spring segment adjacent the first surface, the spring segment urged against the first surface wherein a point end of a fishing hook may be inserted into the opening and secured between the spring segment and the housing first surface. Upon insertion of a fish hook in the housing opening, a barb on the fish hook point engages the second surface, securing the hook in the housing opening. The hook may be removed by urging the hook toward the housing and rotated to disengage the barb from the second surface. The fish hook holding device may include a cavity in the housing for engaging a fishing pole, the cavity adapted for securing the device to the fishing pole. The cavity of the housing may be cylindrical.

Another aspect of the present invention is directed to a fish hook holding device mountable to a fishing pole. The holding device comprises a housing having a plurality of openings for insertion of a first end of a fishing hook and a plurality of first surfaces each surface disposed in the corresponding opening and a plurality of second surfaces substantially perpendicular to the corresponding first surface. The device includes a spring having a plurality of spring segments adjacent the corresponding first surface, each spring segment urged against the corresponding first surface wherein a point end of a fishing hook may be inserted into the opening and secured between the corresponding spring segment and the housing first surface. Upon insertion of a fish hook in at least one of the plurality of housing openings, a barb on the fish hook point engages the corresponding second surface, securing the hook in the at least one housing opening. The hook may be removed by urging the hook toward the housing and rotated to disengage the barb from the second surface. The fish hook holding device may include a cavity in the housing for engaging a fishing pole, the cavity adapted for securing the device to the fishing pole. The cavity of the housing may be cylindrical.

Another aspect of the present invention is directed to a fishing accessory for preventing the tangling of a fishing line on a fishing pole comprising, a base attachable to the fishing pole and extending therefrom. The fishing accessory includes an adjustable guide member movable from a first position wherein a portion of the guide member contacts a guide surface of the base to a position wherein the portion of the guide member is positioned distant from the guide surface. The fishing accessory includes an adjustment member extending from the guide member or the base, the adjustment member engaged with the base wherein moving the adjustment member in one direction moves the guide member away from the guide surface and moving the adjustment member in the opposite direction moves the guide member closer to the guide surface. The position of the guide member is adjustable toward and away from the guide surface to accommodate a specific diameter fishing line. The fishing line may be placed between a first end of the guide member and the guide surface and slid toward a central portion of the guide member until the fishing line is secured between the guide member and the guide surface to restrict longitudinal movement of the fishing line. The accessory base may have a primary axis and an outer surface and the guide surface may extend along a portion of the base in the general direction of the primary axis and the adjustable guide member may be an elongated rod having a length, a guide member second end opposite the first end and a rounded portion extending from the second end wherein the fishing line is placed between the guide member rounded portion and slide along the guide member until the fishing line is secured between the guide member and the guide surface to restrict longitudinal movement of the fishing line. The guide surface may be an inclined surface extending gradually in the direction of the primary axis and extending sharply inward from the accessory base outer surface toward the primary axis and a first portion of the guide member may contact the inclined surface at a location where the inclined surface intersects the primary surface to a position wherein the first portion of the guide member is positioned distant from the inclined surface, the guide member having a second end including a rounded portion extending from the first portion. The fishing accessory may include a channel perpendicular to the primary axis and adjacent the inclined surface where the inclined surface intersects the outer surface of the elongated accessory base, the fishing line securable in the channel when the fishing line is slid along the guide member until the fishing line contacts the channel. The guide member may include a flexible elongated portion which bends when the fishing line is slid along the guide member, the guide member providing a force which holds the fishing line against the guide surface. The fishing accessory may include a groove in the accessory base guide surface extending in the direction of the guide member, the groove engagable with the elongated guide member wherein the member is engaged with the groove when the guide member is in the first position. The adjustment member may be a threaded cylindrical rod slidingly disposed in a cylindrical opening extending through the accessory base, the cylindrical opening having a first and second end, the fishing accessory including a threaded nut engagable with a distal end of threaded adjustment member, the distal end protruding from the first end of the cylindrical opening, wherein turning the nut in one direction moves the guide member closer to the guide surface and turning the nut in the opposite direction moves the guide member away from the guide surface. The fishing accessory may include a compression spring disposed around the adjustment member and adjacent a cylindrical opening second end, the compressing spring urging the guide member away from the contact surface. The fishing accessory base may be arcuate along the contact surface and the guide member is arcuate in a plane parallel with the contact surface. The fishing accessory may include a guide pin parallel with the adjustment member and extending from the guide member, the guide pin slidingly engaged with a guide opening in the accessory base wherein moving the adjustment member in either direction moves the guide pin in the same direction. The fishing accessory base may be integrated into the fishing pole. The fishing pole may include a plurality of casting guides wherein the adjustable guide member may be integrated into at least one of the casting guides. The fishing accessory may include a hook threader for a fishing accessory. The hook threader comprises a circular opening extending through a fishing accessory elongated member, the circular opening having a central axis and a rectangular slot extending perpendicular to the circular opening. The rectangular slot has a height extending in the direction of the circular opening central axis, a width extending the length of the fishing accessory and a depth extending from an outer surface of the fishing accessory toward the circular opening. The rectangular slot extends from the outer surface of the fishing accessory to the circular opening. The hook threader includes a funneled opening juxtaposed with the circular opening, the funnel opening wider at the fishing accessory outer surface and tapering down to the diameter of the circular opening adjacent the rectangular slot. The hook threader includes a channel disposed in a second surface of the rectangular slot opposite the rectangular slot surface adjacent the funneled opening, the channel extending from the fishing accessory surface to the circular opening. A fishing hook eyelet disposed on a fishing hook is insertable into the rectangular slot and a fishing line is insertable into the funneled opening, the fishing line passing through the eyelet of the hook. The fishing accessory may include a hook holder for a fishing accessory comprising at least one opening extending through a fishing accessory elongated member, the opening having a central axis and a magnet disposed sufficiently close to the opening for the magnetic field to hold a fishing hook engaged in the at least one opening. The fishing accessory may include a fishing line cutter comprising an opening in the fishing accessory base, a blade disposed in the opening, the blade having a sharp edge extending adjacent a surface of the fishing accessory elongated member.

Another aspect of the invention is directed to a method for using the fishing accessory. The method includes providing a fishing pole having a rod and a reel and the fishing accessory, ensuring the fishing accessory is fastened to the fishing pole and positioning the adjustment member for a specific diameter fishing line. The method includes placing the fishing line adjacent the first end of the guide member and sliding the fishing line along the guide member until the fishing line is secured between the contact surface and the guide member.

Another aspect of the present invention is directed to a tensioning casting guide for attachment to a fishing pole comprising a ring having a guide surface disposed on a portion thereof and an adjustable guide member movable from a first position wherein a portion of the guide member contacts the guide surface of the casting guide to a position wherein the portion of the guide member is positioned distant from the guide surface. The casting guide includes an adjustment member extending from the guide member, the adjustment member engaged with the casting guide wherein moving the adjustment member in one direction moves the guide member away from the guide surface and moving the adjustment member in the opposite direction moves the guide member closer to the guide surface. The position of the guide member is adjustable toward and away from the guide surface to accommodate a specific diameter fishing line. The fishing line may be placed between a first end of the guide member and the guide surface and slid toward a central portion of the guide member until the fishing line is secured between the guide member and the guide surface to restrict longitudinal movement of the fishing line, preventing the tangling of the fishing line on a fishing pole. The casting guide may include a compression spring disposed around the adjustment member and an adjustment fastener engagable with the adjustment member, the compressing spring urging the guide member away from the guide surface, whereby moving the adjustment fastener in one direction moves the guide member away from the guide surface and moving the adjustment fastener in the opposite direction moves the guide member toward the guide surface. The adjustment member may be a threaded cylindrical rod slidingly disposed in a cylindrical opening extending through the casting guide ring, the cylindrical opening having a first and second end, the casting guide including a threaded nut engagable with a distal end of threaded adjustment member, the distal end protruding from the first end of the cylindrical opening, wherein turning the nut in one direction moves the guide member closer to the guide surface and turning the nut in the opposite direction moves the guide member away from the guide surface. The casting guide may include a guide pin parallel with the adjustment member and extending from the guide member, the guide pin slidingly engaged with a guide opening in the casting guide ring wherein moving the adjustment member in either direction moves the guide pin in the same direction. The casting guide may be integrated into the fishing pole or may be attachable to the fishing pole. Another aspect of the casting guide is directed to a method for using the casting guide for preventing the tangling of a fishing line. The method includes providing a fishing pole including a reel disposed near one end of the fishing pole, an end casting guide disposed on the opposite end of the fishing pole and the tensioning casting guide. The method includes positioning the adjustment member for a specific diameter fishing line, ensuring a fishing line extends from the reel to the end casting member and placing a portion of the fishing line extending from the end casting guide adjacent the end of the guide member. The method includes sliding the fishing line along the guide member until the fishing line is secured between the guide surface and the guide member, leaving a free end of the fishing line extending from the guide surface and pulling on the free end of the fishing line until a tension is placed on the fishing line.

Another aspect of the present invention is directed to a wireform for a fishing accessory for preventing the tangling of a fishing line. The wireform comprises an elongated base member having base member ends and disposable within a groove in the fishing accessory, the fishing accessory having a guide opening extending perpendicular from one end of the groove and an adjustment opening extending in the same direction as the guide opening extending from a central location of the groove. The wireform includes a guide post extending perpendicular from one end of the elongated base member slidingly disposable in the fishing accessory guide opening and a threaded post having external threads, the threaded post extending parallel with the guide post from an inner portion of the elongated base member, the threaded post slidingly disposable in the fishing accessory adjustment opening. The wireform includes an adjustment nut having a ridged perimeter and internal threads engagable with the external threads of the wireform threaded post and a spring disposable about the threaded portion of the threaded post, the spring on the same side of the fishing accessory as the wireform is inserted. The wireform includes a guide member having ends and a length between the ends, the guide member extending from the elongated base end opposite the guide post and a loop extending from the guide member opposite the end of the guide member attached to the elongated base member, the fishing accessory including an inclined ramp alignable with the guide member, the incline extending in the direction of the guide member length and a transverse depression disposed across the groove near the shallow portion of the inclined ramp. A fishing line may be placed between the guide member and the guide surface adjacent the guide member loop and slid toward a central portion of the guide member until the fishing line is secured in the depression to restrict longitudinal movement of the fishing line.

Another aspect of the present invention is directed to a fishing accessory for preventing the tangling of a fishing line comprising an accessory base having an arcuate portion, a straight portion extending from the arcuate portion, the arcuate portion having a first and second opening. The fishing accessory includes a fastening portion extending from a distal end of the straight portion, the fastening portion including a fastener body having a body opening extending therethrough, a threaded thumbscrew extending through the body opening and engagable with a slotted band extending around a clamp body, the clamp body positionable about a fishing pole rod wherein turning the thumbscrew in one direction tightens the clamp body against the fishing pole rod and turning the thumbscrew in the opposite direction loosens the clamp body from the fishing pole rod. The fishing accessory includes a plurality of hook openings in the straight portion of the fishing accessory and a plurality of magnets, each magnet positioned adjacent one of the hook openings and a wireform having an arcuate rod alignable with a groove disposed in the arcuate portion of the accessory, a first finger extending perpendicular from one end of the arcuate rod and a second finger having external threads and extending parallel with the first finger from a central location on the arcuate rod and a loop extending from an opposite end of the arcuate rod opposite the one end of the arcuate rod. The fishing accessory includes a circular nut having a ridged perimeter and internal threads engagable with the external threads of the wireform second finger. The first finger is positionable in the first opening of the arcuate portion and the second finger is positionable in the second opening of the arcuate portion and the circular nut engages the external threads of the second finger from the opposite side of the arcuate portion from which the second finger is inserted.

Another aspect of the present invention is directed to a method for using a fishing accessory for preventing the tangling of a fishing line comprising providing a fishing pole having a rod and a reel. The method includes providing a fishing accessory comprising an accessory base having an arcuate portion, a straight portion extending from the arcuate portion, the arcuate portion having a first and second opening and a fastening portion extending from a distal end of the straight portion, the fastening portion including a fastener body having a body opening extending therethrough, a threaded thumbscrew extending through the body opening and engagable with a slotted band extending around a clamp body, the clamp body positionable about a fishing pole rod wherein turning the thumbscrew in one direction tightens the clamp body against the fishing pole rod and turning the thumbscrew in the opposite direction loosens the clamp body from the fishing pole rod. The fishing accessory includes a plurality of hook openings in the straight portion of the fishing accessory and a plurality of magnets, each magnet positioned adjacent one of the hook openings and a wireform having an arcuate rod alignable with a groove disposed in the arcuate portion of the accessory, a first finger extending perpendicular from one end of the arcuate rod and a second finger having external threads and extending parallel with the first finger from a central location on the arcuate rod and a loop extending from an opposite end of the arcuate rod opposite the one end of the arcuate rod. The fishing accessory includes a circular nut having a ridged perimeter and internal threads engagable with the external threads of the wireform second finger wherein the first finger is positionable in the first opening of the arcuate portion and the second finger is positionable in the second opening of the arcuate portion and the circular nut engages the external threads of the second finger from the opposite side of the arcuate portion from which the second finger is inserted. The method includes providing a fishing pole having a rod and a reel, ensuring the fishing accessory is fastened to the fishing pole and adjusting the circular nut to position the wireform to hold the fishing line. The method includes placing the fishing line adjacent the rounded portion of the guide member and sliding the fishing line along the guide member until the fishing line is secured between the contact surface and the guide member. The fishing accessory may include a hook threader for a fishing accessory comprising a circular opening extending through a fishing accessory elongated member, the circular opening having a central axis. The hook threader includes a rectangular slot extending perpendicular to the circular opening, the rectangular slot having a height extending in the direction of the circular opening central axis, a width extending the length of the fishing accessory and a depth extending from an outer surface of the fishing accessory toward the circular opening, the rectangular slot extending from the outer surface of the fishing accessory to the circular opening. The hook threader includes a funneled opening juxtaposed with the circular opening, the funnel opening wider at the fishing accessory outer surface and tapering down to the diameter of the circular opening adjacent the rectangular slot and a channel disposed in a second surface of the rectangular slot opposite the rectangular slot surface adjacent the funneled opening, the channel extending from the fishing accessory surface to the circular opening. A fishing hook eyelet disposed on a fishing hook is insertable into the rectangular slot and a fishing line is insertable into the funneled opening, the fishing line passing through the eyelet of the hook. The fishing accessory may include a hook holder for a fishing accessory comprising at least one opening extending through a fishing accessory elongated member, the opening having a central axis and a magnet disposed sufficiently close to the opening for the magnetic field to hold a fishing hook engaged in the at least one opening. The fishing accessory may include a fishing line cutter for a fishing accessory comprising an opening in a fishing accessory elongated member and a blade disposed in the opening, the blade having a sharp edge extending adjacent a surface of the fishing accessory elongated member.

The fishing line that extends from the top casting guide at the end of the fishing pole rod is pulled back toward the reel and engages guide member and base groove. The fishing accessory may be secured to the fishing pole at any position and extends parallel to the casting guides. The preferred attachment location is 1 to 3 inches above the bottom casting guide. The device body may be hook shaped and may have a pointed end similar to a fishing hook, although the pointed end may not have a specific function. The wireform may include a threaded post, guide post and an eyelet at the opposite end of the wireform as the guide post. The wireform may be flexible and may be made of a spring material to allow the wireform to flex when the user is inserting or removing the fishing line. The wireform may include a main arc portion which includes the threaded post and the guide post. The wireform may also include an offset arc portion which includes the eyelet. The wireform may be disposed in an arc shaped channel of the device and may be adjustable from a position where the wireform is completely within the groove to a position wherein the wireform eyelet is disposed fully outside of the channel. The threaded post may engage an adjustment nut in the device body which the user may use to move the wireform toward and away from the channel for adjusting for the line diameter. The device may include a notch in the device body perpendicular to the arc of the channel. The fishing line may be slid against the offset portion of the wireform until the line engages the notch to maintain tension and hold the line. The device may be used to maintain tension on the fishing line in the process of spooling new line on a reel.

In operation, to secure the fishing line, the fishing line is passed between the eyelet and the ramp toward the notch until the fishing line is fully secured in the notch. To discharge the line from the device, the user pulls in the opposite direction until the fishing line flexes the wireform sufficient to move the wireform away from the notch, releasing the fishing line from the notch without damaging the fishing line.

The present invention is a fishing accessory for preventing the tangling of a fishing line comprising an accessory base having an arcuate portion, a straight portion extending from the arcuate portion, the arcuate portion having a first and second opening; a fastening portion extending from a distal end of the straight portion, the fastening portion including a fastener body having a body opening extending therethrough, a threaded thumbscrew or similar fastener extending through the body opening and engagable with a slotted band extending around a clamp body, the clamp body positionable about a fishing pole rod wherein turning the thumbscrew in one direction tightens the clamp body against the fishing pole rod and turning the thumbscrew in the opposite direction loosens the clamp body from the fishing pole rod; a plurality of hook openings in the straight portion of the fishing accessory and a plurality of magnets, each magnet positioned adjacent one of the hook openings; a wireform having an arcuate rod alignable with a groove disposed in the arcuate portion of the accessory, a first finger extending perpendicular from one end of the arcuate rod and a second finger having external threads and extending parallel with the first finger from a central location on the arcuate rod and a loop extending from an opposite end of the arcuate rod opposite the one end of the arcuate rod; a circular nut having a ridged perimeter and internal threads engagable with the external threads of the wireform second finger; wherein the first finger is positionable in the first opening of the arcuate portion and the second finger is positionable in the second opening of the arcuate portion and the circular nut engages the external threads of the second finger from the opposite side of the arcuate portion from which the second finger is inserted.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a perspective view of a fishing accessory fastened to a fishing rod according to the present invention.

FIG. 2A is a bottom right rear perspective view of the fishing accessory according to the present invention.

FIG. 2B is a top left perspective view of the fishing accessory shown in FIG. 1.

FIG. 3 is a top elevational view of the fishing accessory shown in FIG. 1, mounted on a fishing pole having a reel attached.

FIG. 4 is a bottom elevational view of the fishing accessory shown in FIG. 1.

FIG. 5 is a left elevational view of the fishing accessory shown in FIG. 1.

FIG. 6 is a right elevational view of the fishing accessory shown in FIG. 1.

FIG. 7 is a rear elevational view of the fishing accessory shown in FIG. 1.

FIG. 8 is a front elevational view of the fishing accessory shown in FIG. 1.

FIG. 9 is an exploded front elevational view of a fishing line holding system according to the present invention.

FIG. 10 is a front elevational view of the fishing line holding system shown in FIG. 9, holding a large diameter fishing line.

FIG. 11 is a front elevational view of a fishing line holding system shown in FIG. 9, holding a small diameter fishing line.

FIGS. 12A, 12B, 13 and 14 show the steps in using the fishing line holding system shown in FIG. 9.

FIG. 15 shows a perspective view of an arcuate embodiment of the fishing line holding system according to the present invention.

FIG. 16 shows a perspective view of the arcuate embodiment of the fishing line holding system shown in FIG. 15.

FIG. 17 shows a perspective view of the arcuate embodiment of the fishing line holding system shown in FIG. 15.

FIG. 18 is a left side perspective view of the fishing line threading cone according to the present invention.

FIG. 19A is a top perspective view of the fishing line threading cone shown in FIG. 18; and FIG. 19B is a top perspective view of the fishing line threading cone showing the line and hook engaged in the threading cone.

FIG. 20 is a rear perspective view of the fishing accessory fastening system according to the present invention.

FIG. 21 is a left top perspective view of the fishing accessory fastening system shown in FIG. 20.

FIG. 22 is a perspective view of the fishing hook holding system according to the present invention.

FIG. 23 is a perspective view of the fishing line cutting system according to the present invention.

FIG. 24 is a perspective view of the lower half of a fishing pole having a fishing accessory according to the present invention integrated with the fishing pole.

FIG. 25 is a perspective close-up of the fishing accessory shown in FIG. 24.

FIG. 26 is a front elevational view of the fishing accessory including the securing post for attaching to a fishing rod.

FIG. 27 is a bottom elevational view of the fishing accessory shown in FIG. 26.

FIG. 28 is a side view of a threader tip according to the present disclosure attached to a housing.

FIG. 29 is an exploded side view of the threader tip and housing of FIG. 28.

FIG. 30 is a side sectional view of the threader tip and housing of FIG. 28.

FIG. 31 is an isometric view of the threader tip of FIG. 28.

FIG. 32 is an isometric view of a sheath compatible with the threader tip and housing of FIG. 28.

FIG. 33 is a top left front perspective view of an alternate embodiment of a hook holder according to the present invention.

FIG. 34 is a front right bottom perspective view of the hook holder shown in FIG. 33 attached to a fishing accessory mountable on a fishing pole.

FIG. 35 is a top left front perspective view of the spring for the hook holder shown in FIG. 33.

FIG. 36 is a front right bottom perspective view of the spring and spring housing for the hook holder shown in FIG. 33.

FIG. 37 is a front cutaway view of the hook holder shown in FIG. 33.

### DESCRIPTION OF THE PREFERRED EMBODIMENT(S)

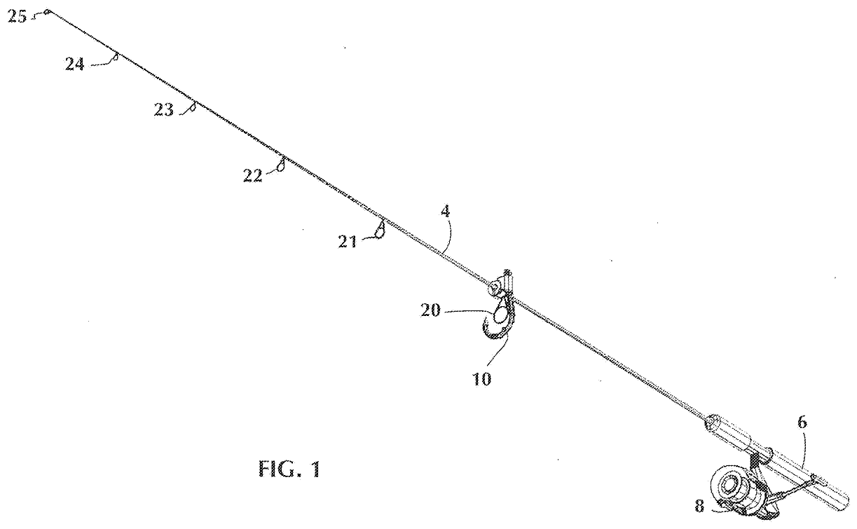

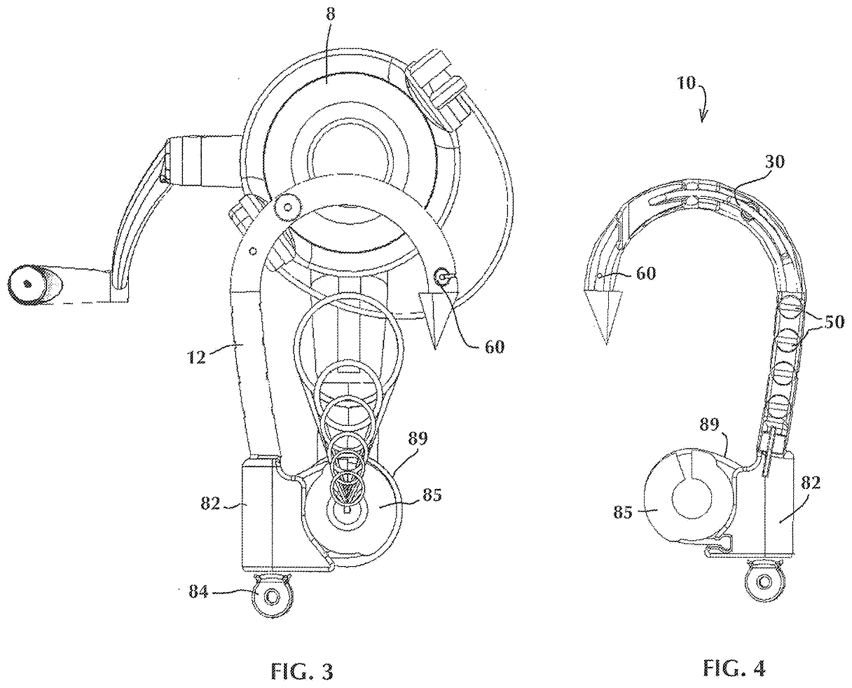

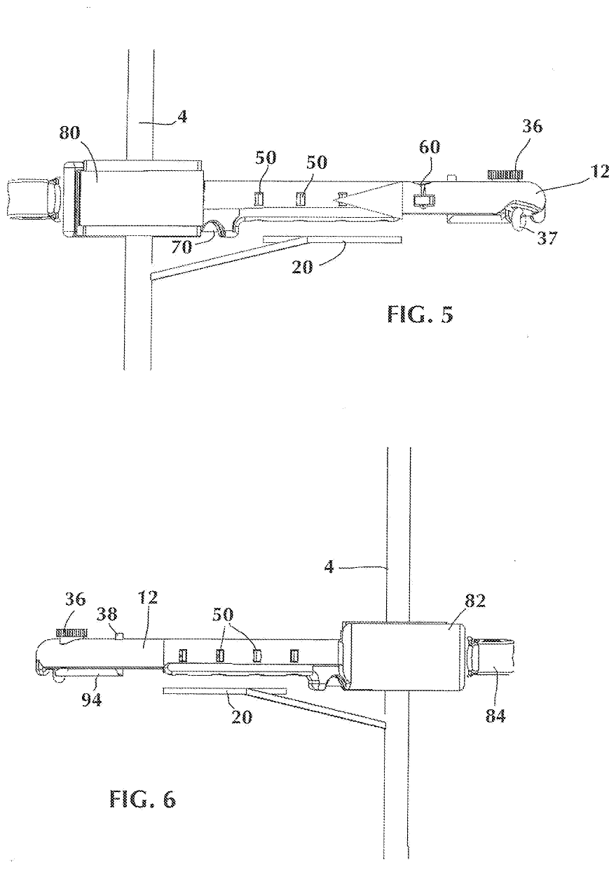

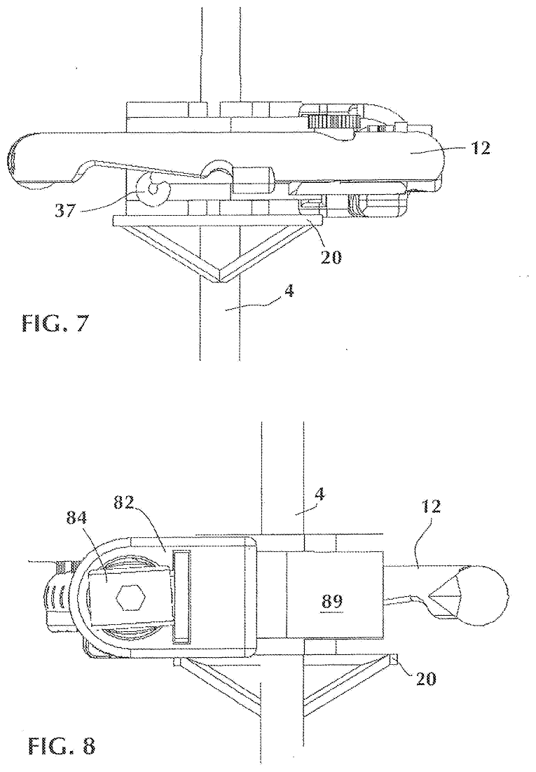

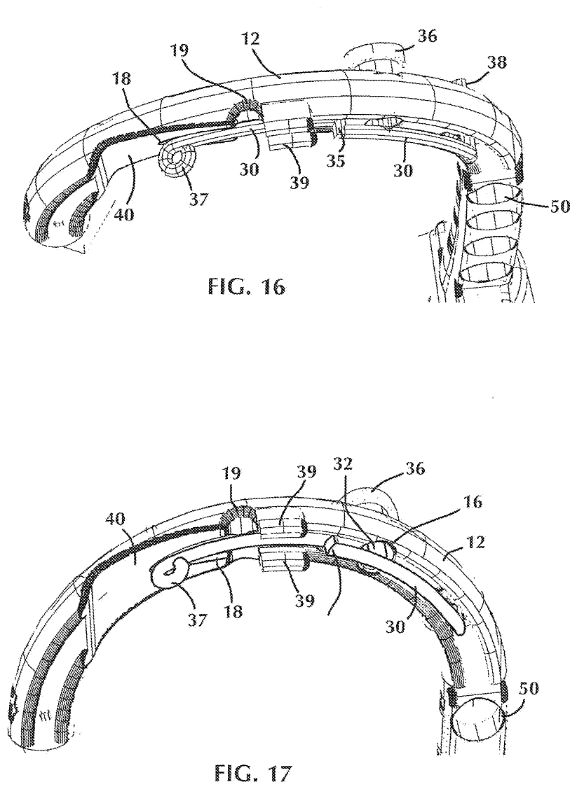

In describing the preferred embodiment of the present invention, reference will be made herein to FIGS. 1-37 of the drawings in which like numerals refer to like features of the invention.

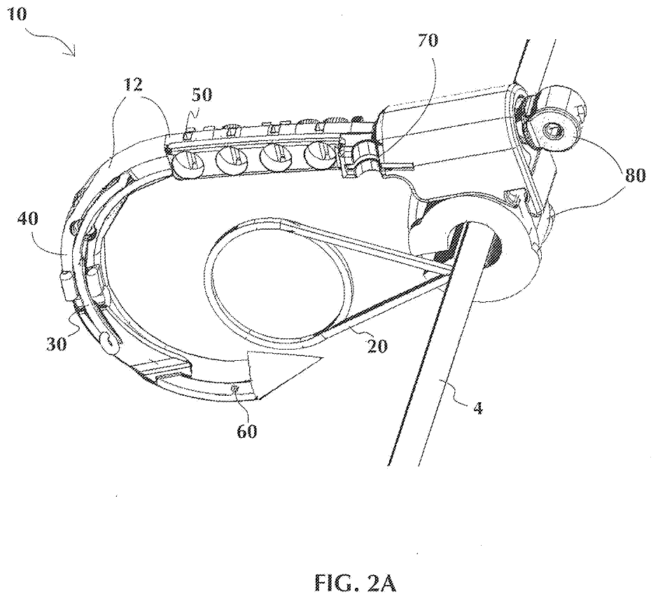

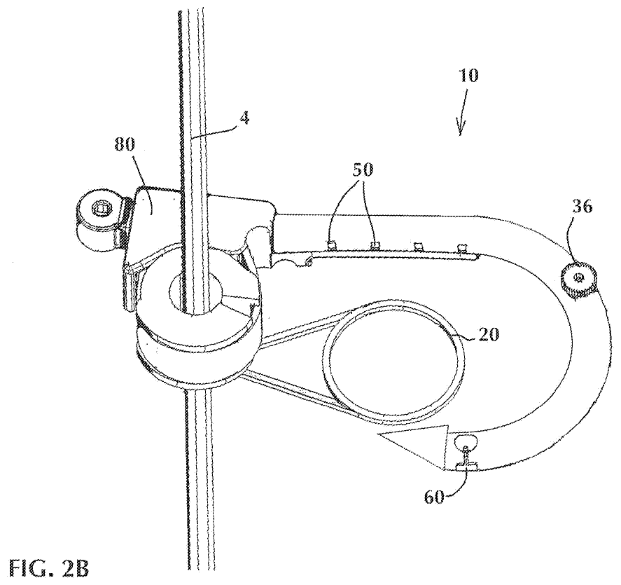

FIG. 1 shows the fishing accessory 10 attached to a fishing pole having a rod 4, reel 8, a handle 6 and a plurality of fishing pole casting guides 20-25. The fishing accessory 10 is attached to the lower casting guide 20. FIGS. 2-8 show one embodiment of the fishing accessory for preventing the tangling of a fishing line on a fishing pole. The fishing accessory 10 includes a wireform or guide member 30 and guide surface 40 for putting tension on the fishing line to prevent tangling. A plurality of hook holders 50, a line threader 60 and a line cutter 70 are disposed on a portion of the accessory base 12. A fastening system 80 is disposed at one end of the accessory base 12 for attaching the fishing accessory 10 to the pole 4 or may be attached to a portion of the lower casting guide 20. The fishing accessory may be removably attachable to the fishing pole or may be integrated into the fishing pole. The arcuate portion of the fishing accessory is attached to the side of the rod away from the user but may also be used in any orientation on the fishing pole.

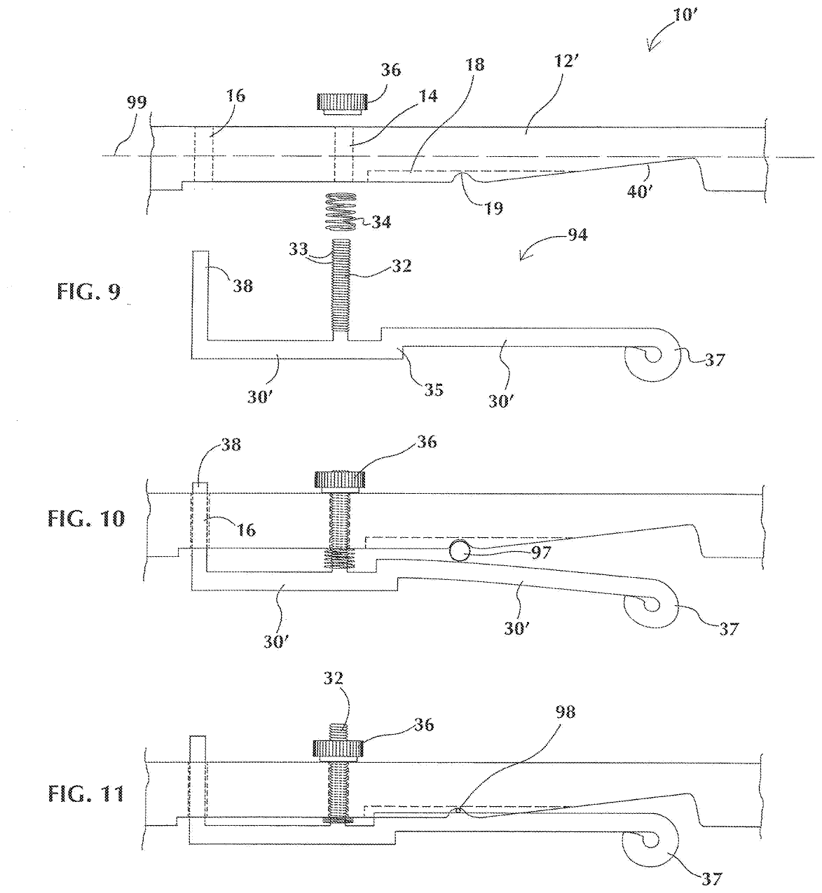

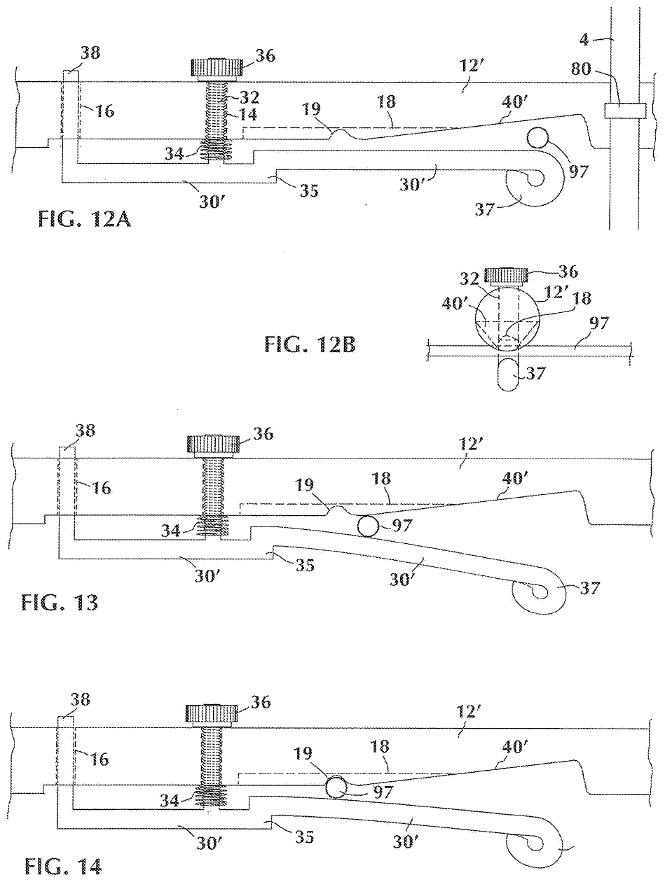

FIGS. 9-14 show one embodiment of the fishing accessory 10′ having a base 12′, a wireform 94 including a guide member 30′ and guide surface 40′. The embodiment shown in FIGS. 9-14 have a relatively straight base 12′, guide member 30′ and surface 40′ in contrast to the arcuate base 12 and arcuate guide member 30 shown in the remainder of the drawings. The fishing accessory 10′ comprises a base 12′ attachable to the fishing pole rod 4 and an adjustable guide member 30′ movable from a first position shown in FIG. 11 wherein a portion of the guide member 30′ contacts or is close to the guide surface 40′ of the base 12′ to a position wherein the portion of the guide member 30′ is positioned distant from the guide surface 40′. An adjustment member 32 extends from the guide member 30′ and is slidingly engagable with an adjustment opening 14 on the base 12′. A cylindrical nut 36 having internal threads engages threads 33 on the adjustment member 32. A compression spring is disposed around the end of the adjustment member 32 where the adjustment member 32 attaches to the guide member 30′. The cylindrical nut 36 engages the external threads 33 on the opposite end of the adjustment opening 14 as the compression spring 34. Moving the adjustment member 32 in one direction by rotating the cylindrical nut 36 moves the guide member 30′ away from the guide surface 40′ and moving the adjustment member 32 in the opposite direction moves the guide member 30′ closer to the guide surface 40′. The position of the guide member 30′ is therefore adjustable toward and away from the guide surface 40′ to accommodate specific diameters of fishing line 97, 98. As shown in FIGS. 12-14, the fishing line 97 is placed between a first end of the guide member 30′ and the guide surface 40′ and slid toward an offset 35 disposed at a central portion of the guide member 30′ until the fishing line 97 is secured between the guide member 30′ and the guide surface 40′ to restrict longitudinal movement of the fishing line. The fishing accessory shown in FIGS. 9-11 may be attachable to the fishing pole or may be integrated into the fishing pole.

The wireform 94 includes a guide member 30′, the guide member 30′ with or without an offset 35. The wireform 94 may have spring-like properties in order to flex when the fishing line is inserted or extracted from the fishing accessory. The guide member 30′ includes ends and is disposable within a groove 18 in the fishing accessory base 12′. The base 12′ includes a guide opening 16 and an adjustment opening 14 extending in parallel with the guide opening 16. A guide post 38 extends perpendicular from one end of the guide member 30′ and is slidingly disposed in the guide opening 16. An adjustment post or adjustment member 32 extends parallel to the guide post 38, the adjustment member 32 disposed proximate to the offset 35 and slidingly disposed in the adjustment opening 14. The adjustment member 32 includes external threads 33. An adjustment nut 36 may have a ridged perimeter and the internal threads are engagable with the external threads of the adjustment member 32. A spring 34 is disposed about the threaded portion 33 of the adjustment member 32, the spring 34 disposed on the same side of the base 12′ that the wireform 94 is inserted into the base 12′. A loop 37 extends from the guide member 30′ end opposite the end of the guide member 30′ having the guide member 38. The base 12′ includes a guide surface 40′ which may be inclined and is alignable with a portion of the guide member 30′, the inclined guide surface 40′ extending in the direction of the guide member 30′ length. The base 12′ includes a transverse depression 19 disposed across the groove 18 near the shallow portion of the inclined surface 40′. A fishing line 97, 98 may be placed between the guide member 30′ and the guide surface 40′ adjacent the guide member loop 37 and slid toward an offset 35 or central portion of the guide member 30′ until the fishing line 97, 98 is secured in the depression 19 to restrict longitudinal movement of the fishing line 97, 98.

FIGS. 12-14 show a method of using the fishing accessory 10′. The method for using the fishing accessory includes ensuring the fishing accessory is attached to the fishing rod 4 using a fastener 80 and positioning the adjustment member 32 for a specific diameter fishing line. The fishing line is then placed adjacent the end of the guide member 30′ having the loop 37 and the fishing line 97 is slid along the guide member 30′ until the fishing line 97 is secured between the guide surface 40′ and the guide member 30′. The base 12′ may include a depression 19 disposed transverse to the groove 18 near the shallow portion of the inclined surface 40′ wherein the fishing line is slid along the guide member until the fishing line is secured in the base depression 19 by the guide member 30′.

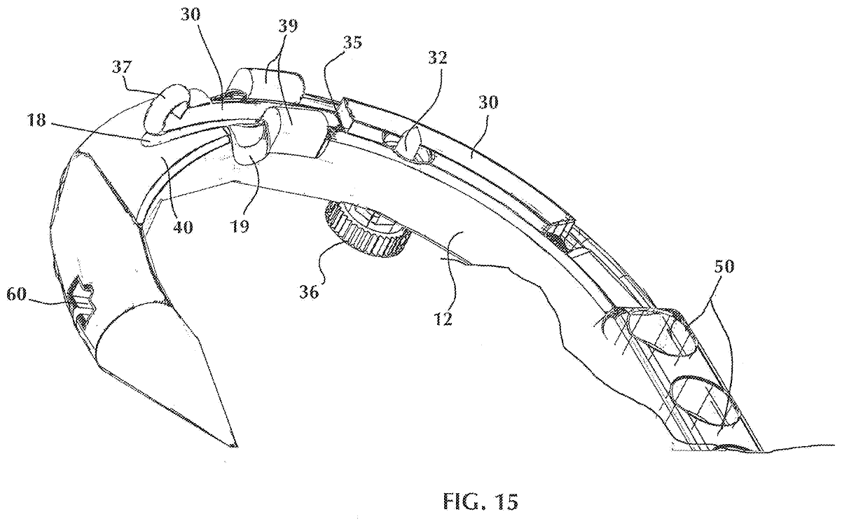

FIGS. 15-17 show perspective views of an arcuate embodiment of the fishing accessory. A guide member 30 includes an offset 35 disposed between the adjustment member 32 and the loop 37. The portion of the guide member 30 disposed between the offset 35 and loop 37 engages a groove 18 in the guide surface 40 of accessory base 12. A depression 19 is disposed transverse to the length of the groove 18 and a pair of line stops 39 are disposed adjacent the depression. The stops 39 prevent the fishing line from moving past the depression 19 as the fishing line is slid from a position between the loop 37 and the guide surface 40 inward toward the depression 19 until the fishing line is secured between the guide member 30 and the depression. The adjustment fastener or cylindrical nut 36 is rotated to move the guide member 30 toward or away from the guide surface 40, providing an adjustment so the guide member 30 flexes as the fishing line is slid toward the depression 19, the flexibility of the guide member 30 providing the pressure securing the fishing line into depression 19. The cylindrical nut 36 also provides adjustment to vary the tension which is placed on the fishing line and to accommodate various diameter fishing lines.

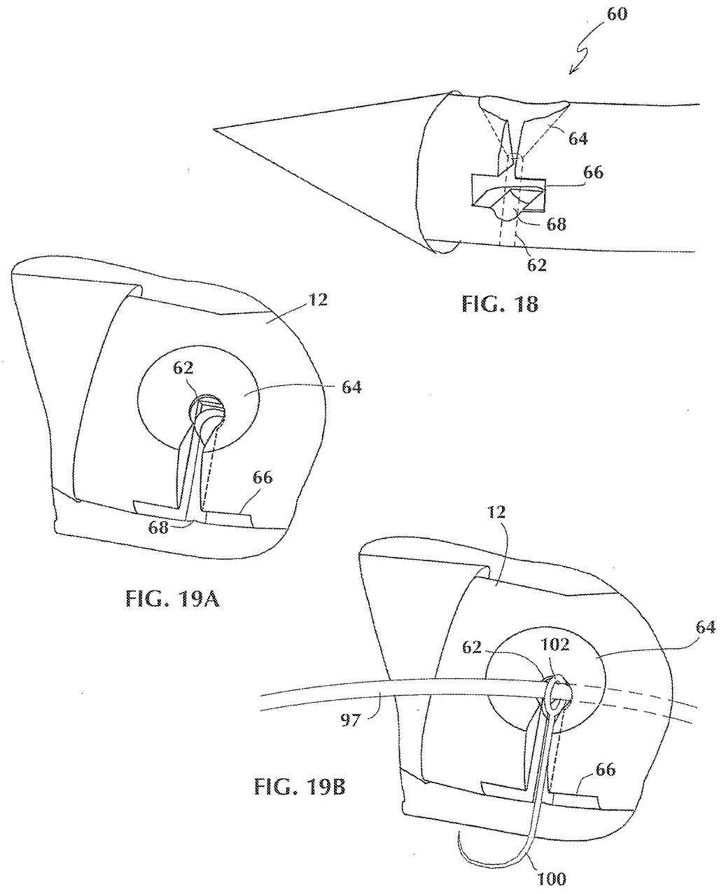

As shown in FIGS. 18 and 19, the fishing accessory may include a fishing line threader 60 to aid in the securing of a hook 100 to a fishing line 97, such as the threading of a fishing line 97 through a fish hook eyelet 102. The threader 60 includes an accessory base 12 having a line threader opening 62 extending fully through the base 12. An upper portion of the opening 62 includes a funnel 64 for guiding the fishing line 97 into the remainder of the opening 62. A rectangular slot 66 is disposed partially through the base 12 perpendicular to and intersecting the opening 62. A slot channel 68 extends along the bottom of the slot 66. In operation as shown in FIG. 19, the hook eyelet 102 is positioned into the slot 66 until the eyelet 102 is axially aligned with the opening 62. An end of the fishing line 97 is guided into the funnel 64 and through the eyelet 102 and the remainder of the opening 62. As the hook 100 is removed from the slot 66, the slot groove 68 allows the portion of the fishing line 97 extending from the bottom of the opening 62 to slide out of the slot 66 without binding at the bottom of the slot 66. A knot may then be made in the fishing line to secure the fishing line 97 to the hook 100.

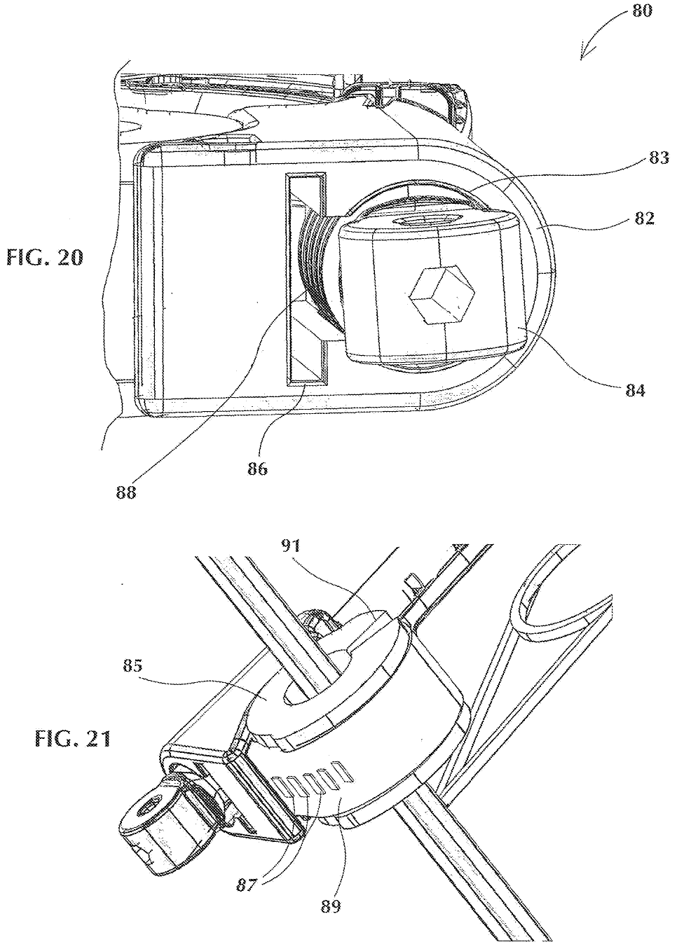

FIGS. 20 and 21 show the fastening system 80 for attaching the fishing accessory to a fishing pole or a fishing pole rod. The system includes a fastening base 82 and a circular opening 83 for rotatingly securing a threaded shaft 88 having a knob 84 at one end. The fastening system 80 includes a band 89 having a plurality of parallel teeth 87 for engaging the threaded shaft 88. The band 89 is disposed around the perimeter of a pliable grommet 85 which includes a split 91 for allowing attachment to the fishing rod 4. The band 89 passes through a base slot 86 where a portion of the band 89 having the parallel teeth 87 engage the threaded shaft 88. As the knob 84 is rotated in one direction, the threaded shaft rotates, tightening the band 89 about the grommet 85. As the knob 84 is rotated in the opposite direction, the threaded shaft rotates in the opposite direction, loosening the band 89 about the grommet 85. The teeth 87 may alternately be slots in the band 89 which engage the threaded shaft 88. When the user is finished using the fishing pole and the hook still remains at the end of the fishing line, an opening extending through knob 84 may be used to secure the hook in order to maintain tension on the fishing line when the reel is in the locked position. The hook tip is placed through the opening of the knob 84 and the hook is rotated so the arcuate portion of the hook is engaged with the knob opening.

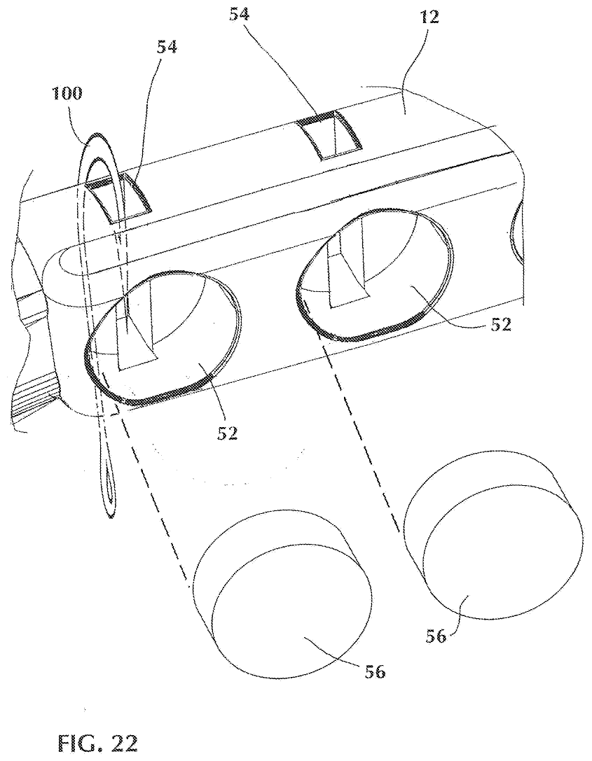

FIG. 22 shows a close up perspective view of a portion of the fishing accessory which includes fishing hook holders 50 for storing extra fish hooks 100. The hook holders 50 include storage openings 54 for placing the hook 100 tip into. Magnets 56 are disposed in magnet openings 52. The magnet openings 52 extend partially through the accessory base 12 and intersect the corresponding storage opening 54 to allow the magnets 56 to directly contact the portion of the hook 100 within the storage opening. The magnets 56 apply an attraction force to the fishing hook 100 once the hook 100 is placed in the storage openings 54. In operation, the hook 100 is placed in the storage opening 54 where the magnet 56 holds the hook 100 in place. To remove the hook 100, the hook 100 is urged out of the storage opening 54 by applying sufficient force to break the magnetic bond between the hook 100 and the magnet 56.

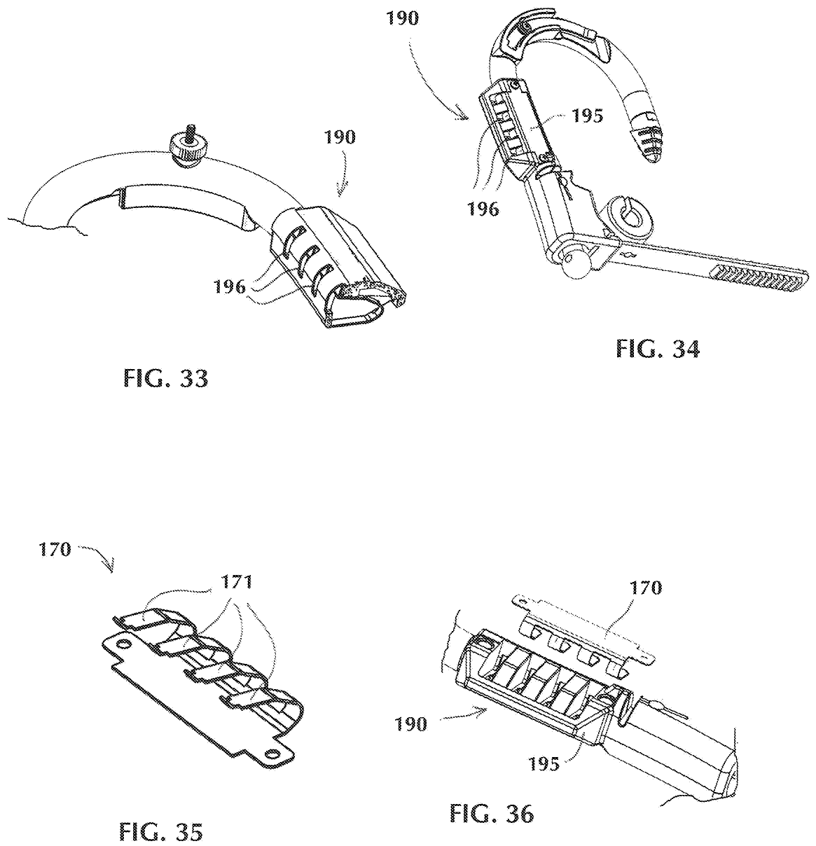

An alternate embodiment of a fishing hook holder 190 is shown in FIGS. 33-37. A hook spring 170 secures the sharp end 180 of the hook 100 against a face 184 in the plastic body and captures the barb 181 of the hook against an adjacent face 186, ensuring the hook 180 will not come out unless the user intentionally removes the hook from the device by pushing the hook down and in, freeing the barb 181. The spring 170 may be diamond coated so every time the user inserts or removes a hook, the tip of the hook will slide against the diamond coated surface of the spring, which will sharpen the hook. As shown in FIG. 35, the spring 170 may include multiple spring segments 171 for holding a plurality of fishing hooks.

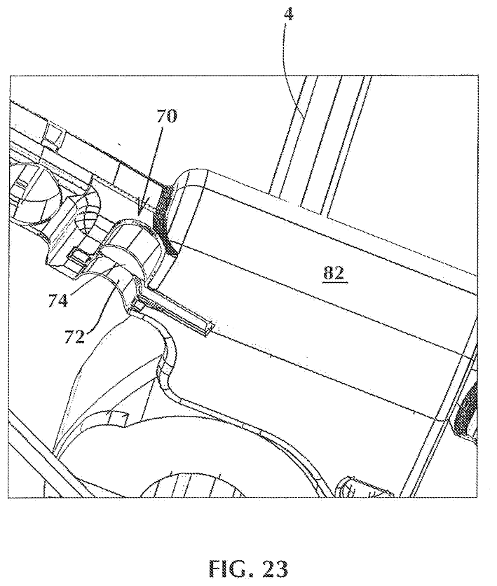

As shown in FIG. 23, the fishing accessory may include a fishing line cutter 70 having a razor blade 74 permanently fixed along a notch 72 along the length of the fishing accessory, preferably at the bottom, away from the tensioning device in order to avoid accidental cuts. The razor blade 74 may be used to cut off excess or compromised fishing line.

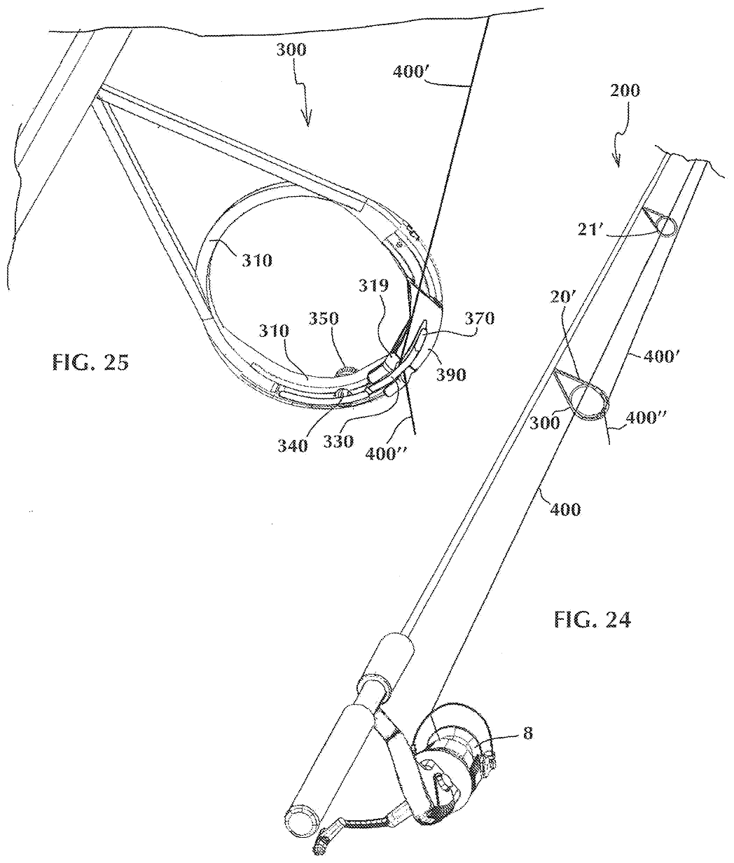

FIG. 24 is a perspective view of the lower half of a fishing pole 200 having a fishing accessory 300 integrated with the fishing pole 200 or integrated into one of the casting guides 20′. FIG. 25 shows a close-up of a tensioning casting guide 300 comprising a line guide member 330 movable toward and away from a guide surface 390 on the casting guide ring 310. The casting guide 300 may be permanently attached to the fishing pole or the casting guide may be attachable to the fishing pole. In operation, the fishing line 400 which extends from the reel 8, through all of the casting guides 20′, 21′, etc. to the upper tip of the rod, may have tension applied by the fishing accessory 300 as the fishing line 400′ extends from the tip of the rod to the line guide 330 or depression 319 and from the line guide the fishing line 400″ extends outward for access by the user. An adjustment fastener 350 and adjustment post 340 may be used to change the position of the guide member 330 with respect to the guide surface 390 for holding various fishing line diameters. Since the fishing line 400 from the reel 8 to the tip of the rod extends within the rings of the casting member 20′, 21′, etc. and the fishing line 400′ extends outside the rings, the tension on both fishing lines 400′, 400″ prevents them from contacting one another and therefore preventing the tangling of the fishing line 400′, 400″. In operation the user pulls out as much fishing line required for repair, locks the reel 8, pulls the fishing line 400′ under the guide loop 370 and between the guide member 330 and guide surface 390 until the fishing line 400′ is secured between the guide member 330 and guide surface 390, the fishing line 400′ preferably engaged in a transverse depression 319 so that the guide member 330 compresses the fishing line in the transverse depression 319. The adjustment fastener 350 may be adjusted to vary the pressure placed on the fishing line 400′ engaged in the transverse depression 319.

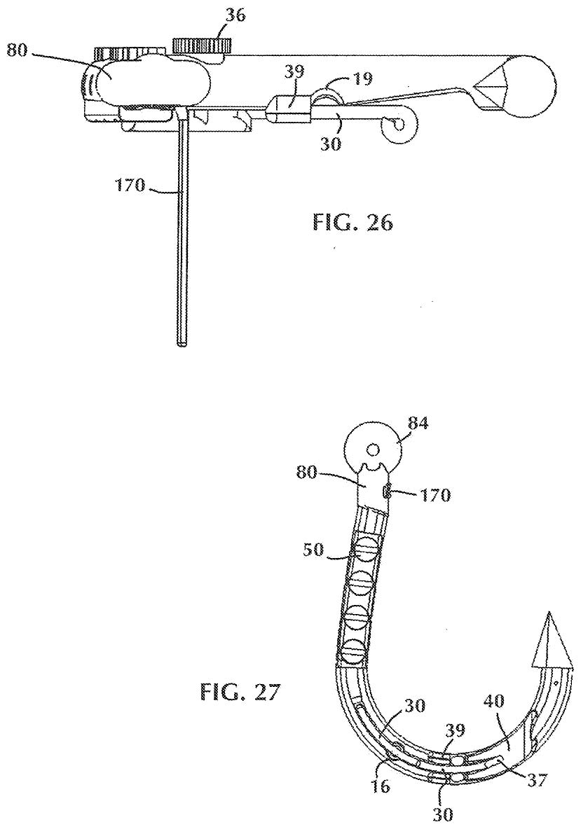

FIGS. 26 and 27 show the fishing accessory having a securing post 170 extending downward from the fastening system 80. The securing post 170 may be used for additional support in securing the fishing accessory to the fishing pole rod. The securing post 170 secures the fishing accessory to the fishing pole rod by placing the securing post against the fishing rod and lacing or wrapping a material around the securing post and the fishing rod. The securing post 170 is preferably metal, but any material which can support the fishing accessory may be used. The wrapping material may be fiberglass, composite, plastic, nylon or any waterproof textile. An adhesive, epoxy, lacquer or the like may be applied to the lacing or wrapping material to permanently secure the fishing accessory to the fishing pole rod by the securing post 170. The securing of the fishing accessory to the fishing pole rod by the securing post may be accomplished during manufacturing or assembly of the fishing rod. The fishing accessory may alternately be secured by the end user. The fishing rod may also be altered to engage the securing post 170 for assembly, such as milling a slot or opening in the fishing pole rod to engage the securing post.

The device may include a bottle opener located on the fishing accessory in order to remove caps from bottles.

The device may include a miniature flashlight that shines outward where the arc of the solid body begins, in order to illuminate areas of interest in the dark. A rechargeable battery may exist within the solid body connected to the light and to a charging port that may exist on the outside of the solid body in order to allow for recharging.

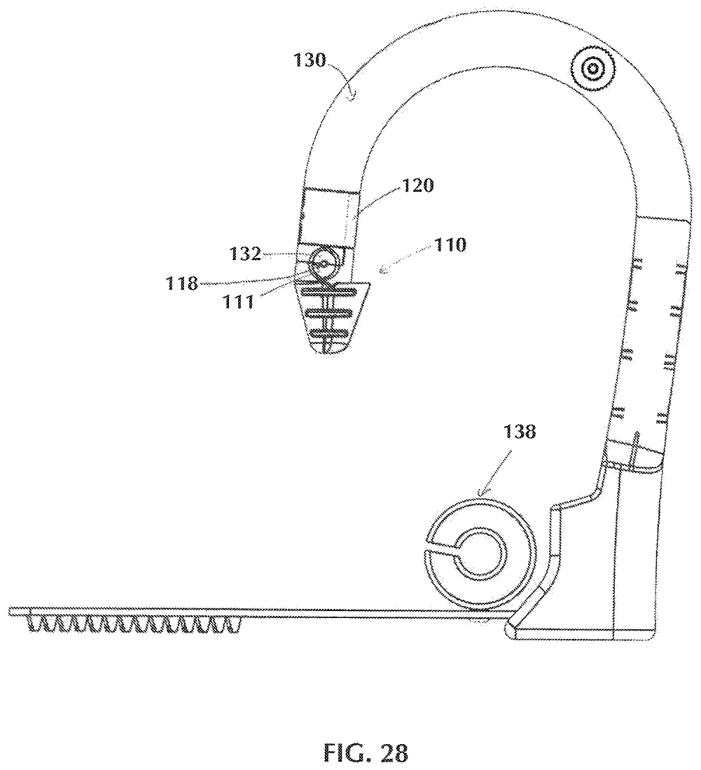

As shown in FIG. 28, a threader tip according the present disclosure is generally designated by the numeral 110. The threader tip 110 is mounted to an end of a housing 130 that attaches to a fishing pole (not depicted) by way of mounting structure 138. Details of the mounting structure 138 and how it attaches to a fishing pole are disclosed in co-pending U.S. patent application Ser. No. 15/383,617, incorporated herein in its entirety. A sheath 120 attaches to the housing 130, near the junction between the housing 130 and the threader tip 110. A first hook groove 132 and a second hook groove 111 form a hook aperture 118, which receives the shank portion of a fish hook (not depicted).

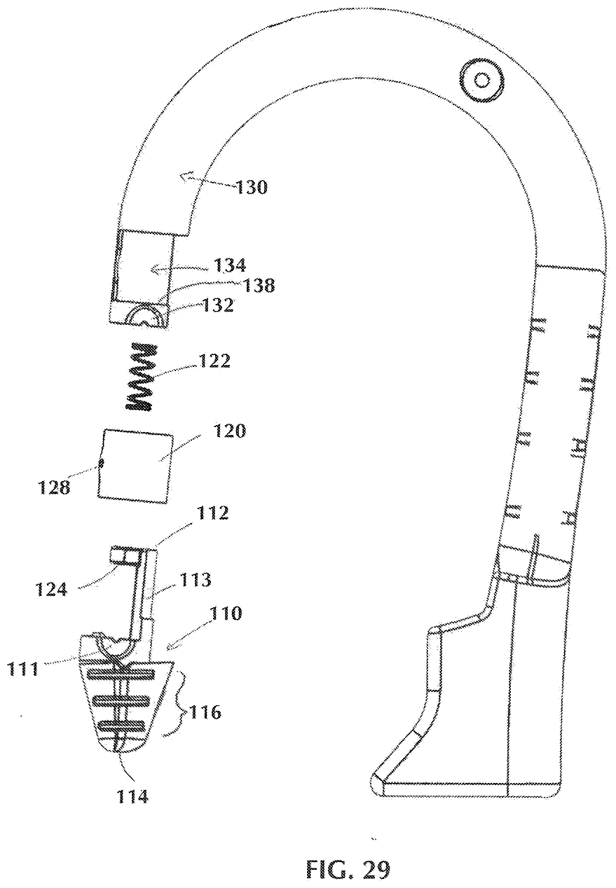

FIG. 29 depicts the threader tip 110 and housing 130 in an exploded view. The housing 130 has a threader gap 134 at the end of the housing 130 near the threader tip 110. The first hook groove 132 is disposed at the end and a housing shoulder 138 proximate to the first hook groove 132 and faces away from the first hook groove 132 to define an edge of the threader gap 134.

The threader tip 110 extends from a first end 112 to a second end 114. In the depicted embodiment, a tip shoulder 124 is located near the first end 112 and faces away from the first end 112. The second hook groove 111 penetrates the threader tip 110 between the first end 112 and the second end 114. A plurality of ridges form a handle 116 near the second end 114 of the threader tip 110.

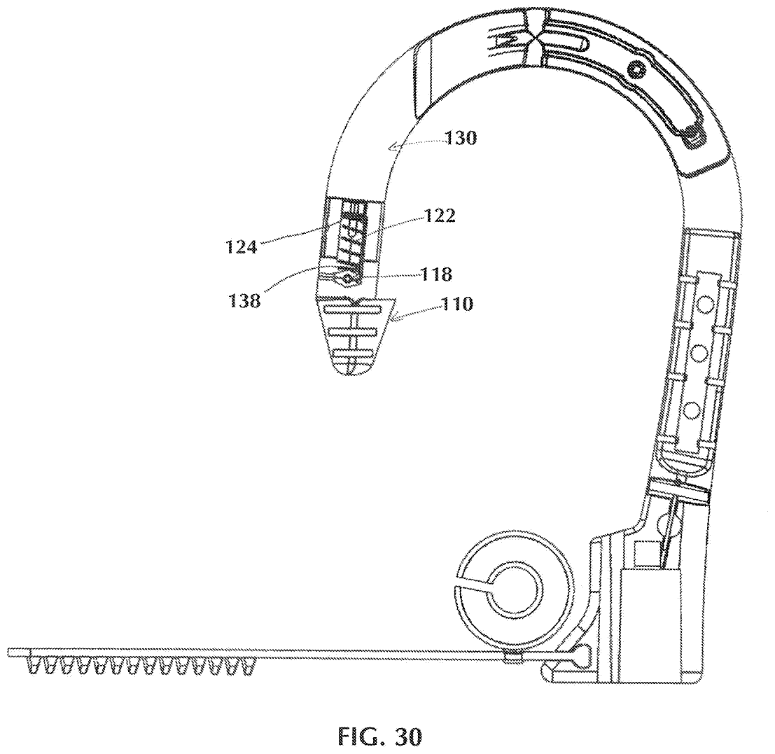

Referring to FIG. 30, a biasing member 122 is retained between the housing shoulder 138 and the tip shoulder 124. In the depicted embodiment, the biasing member 122 exerts opposing spring forces to keep the threader tip 110 in a closed position, as depicted in FIGS. 28 and 30.

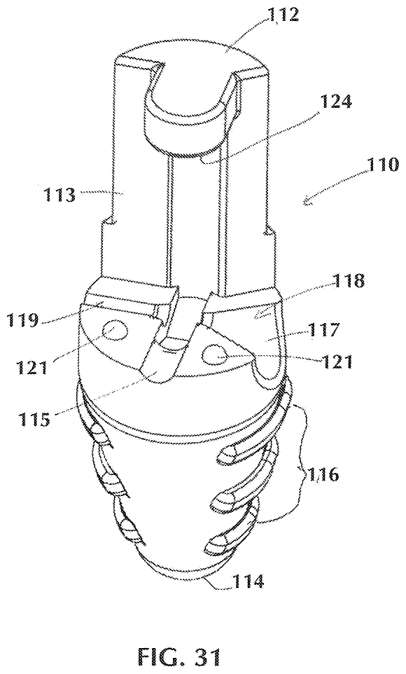

Referring to FIG. 31, the hook aperture 18 is formed on one end by an anvil made up of shank holder 115, threading groove 117, and exit groove 119. In the depicted embodiment, a plurality of spacers 121, assure proper distance between the first hook groove 132 and the second hook groove 111 when the threader tip 110 is in the closed position.

The user inserts the straight shank of a fishing hook, eye end first, into shank holder 115. The user then allows the biasing member 122 to pull the second hook groove 111 towards the first hook groove 32, thereby retaining the fish hook within the hook aperture 118. The user then feeds an end of the fishing line into threading groove 117. The conical or frustoconical shape of the depicted threading groove 117 directs the end of the fishing line through the eye of the fishing hook. The end of the fishing line then exits through exit groove 119. In some embodiments, the end of the fishing line is fed through the anvil multiple times.

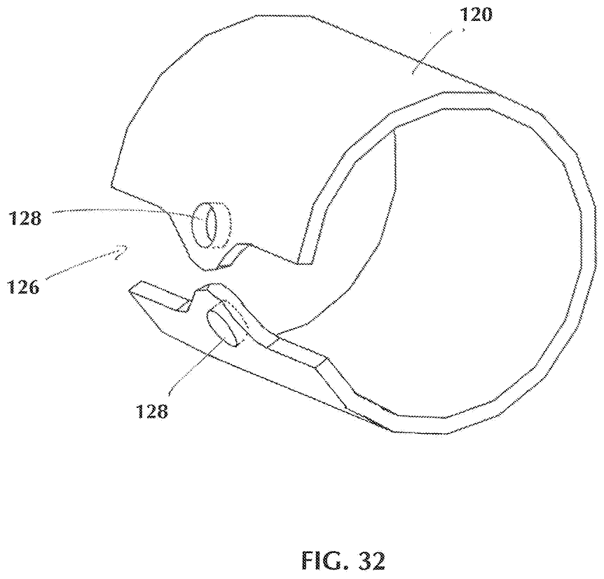

FIG. 32 depicts the sheath 120 with a longitudinal groove 126 that extends the entire length of the sheath 120. In some embodiments, the sheath is cylindrical. A plurality of mounting holes 128 penetrate the sheath 120, with one mounting hole 128 on either side of the longitudinal groove 126. In some embodiments, the longitudinal groove 126 and/or the mounting holes 128 assist during assembly or help retain the sheath over the threader gap 134. The combination of the housing 130, the threader tip 110, the sheath 120, and the biasing member 122 allow a user to thread a hook in a variety of situations. The biasing member 122 retains the threader tip 110 in the closed position when a hook is retained in the hook aperture 118. In some embodiments, a magnet or other suitable retention means are incorporated into the housing 130 and/or threader tip 110.

The arrangement of the hook aperture 118 and the threader tip 110 in the depicted embodiments allows a user to pull the threader tip 110 transverse to the fishing line and/or the fishing rod. This provides easy handholds for the user and increases the safety of threading the fishing line through the fishing hook.

In some embodiments, the sheath 120 also protects the biasing member 122 from particulates, damage, and corrosion during use, transport, and storage.

In some embodiments, the hook aperture 118 is parallel to the fishing pole to minimize the stress placed on the fishing line, the knot, and/or the hook during threading or transportation. In some embodiments, the housing, the sheath, the threader tip, or some combination thereof, entirely conceals the hook. This makes the device significantly safer for the user and offers the hook and line connection additional protection.

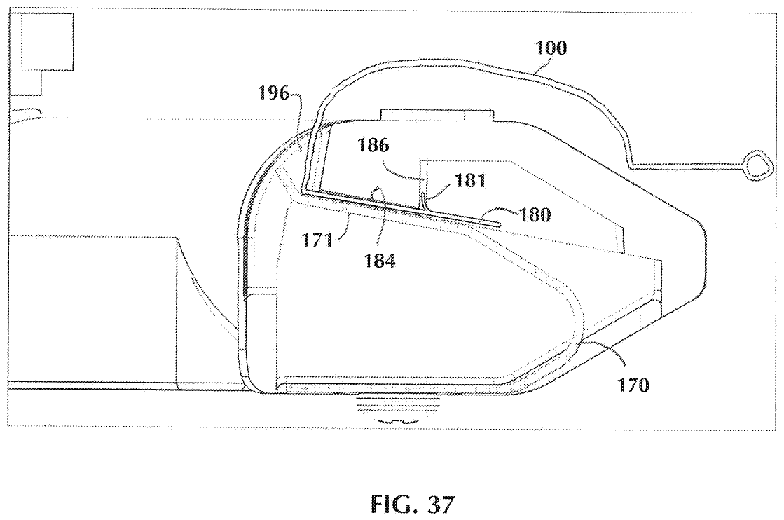

Another embodiment of the present invention shown in FIGS. 33-36 is a fish hook holding device 190 mountable to a fishing pole. The holding device 190 comprises a housing 195 having a cavity and at least one opening 196, preferably a plurality of openings 196 for insertion of a first end 180 of a fishing hook 100 (shown in FIG. 37) and a plurality of contact surfaces or first surfaces 184 each first surface disposed adjacent the corresponding opening 196 and a plurality of barb securing surfaces or second surfaces 186 substantially perpendicular to the corresponding first surface 184. The device 190 includes a spring 170 having at least one and preferably a plurality of spring segments 171 adjacent the corresponding first surface 184, each spring segment 171 urged against the corresponding first surface 184 by the force from the spring wherein a point end 180 of a fishing hook 100 may be inserted into the opening 196 and secured between the corresponding spring segment 171 and the housing first surface 184. Upon continuing insertion of a fish hook point 180 in at least one of the plurality of housing openings 196, a barb 181 on the fish hook point 180 engages the corresponding second surface 186, securing the hook 100 in the at least one housing opening 196. The hook 100 may be removed by urging the hook 100 toward the housing 195 to disengage the barb 181 from the second surface 186 and pushed in a direction opposition the point (downward and left as positioned in FIG. 37), removing the fish hook from the opening. Urging the hook 100 toward the housing 95 pushes the spring segment 171 away from the contact surface or first surface 184. The spring 170 may include a lip at the terminal end of the first surface to prevent the fish hook 100 from sliding out unintentionally. The spring 170 may be diamond coated so every time the user inserts or removes a hook, the tip of the hook will slide against the diamond coated surface of the spring, which will sharpen the hook. The fish hook holding device 190 may include a cavity in the housing for engaging a fishing pole, the cavity adapted for securing the device to the fishing pole. The cavity of the housing may be cylindrical.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

The invention as described above meets the objectives set forth in the summary. The present invention provides a fishing accessory allows for a convenient and safe way to hold the fish hook. The present invention provides a device attachable to a fishing pole which aid in directing and guiding the fishing line. The present invention provides a fishing accessory that prevents tangling of a fishing line as well as provides a fishing accessory which can secure a fishing line of various diameters. The present invention provides a fishing accessory which magnetically secures fishing hooks to the accessory. The fishing accessory is attachable to a fishing pole with a band clamp system. The present invention also provides a fishing accessory which allows easy threading of a fishing line through the fishing hook eyelet and a fishing accessory integrated with the fishing pole or integrated directly into a casting guide.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A fish hook holding device mountable to a fishing pole, the holding device comprising:
a housing having an opening in the housing for insertion of a first end of a fishing hook, the housing mountable to a fishing pole or fishing pole accessory;
a first surface disposed adjacent the opening and a second surface substantially perpendicular to the first surface; and
a spring having a spring segment adjacent the first surface, the spring segment urged against the first surface wherein a point end of a fishing hook may be inserted into the opening and secured between the spring segment and the housing first surface;
wherein upon insertion of a fish hook in the housing opening, a barb on the fish hook point engages the second surface, securing the hook in the housing opening; and
wherein the hook may be removed by urging the hook toward the housing and pushed in a direction opposition the point to disengage the barb from the second surface.

2. The fish hook holding device of claim 1 including an upwardly angled lip at a terminal end of the first surface to secure the fish hook in the fish hook holding device.

3. The fish hook holding device of claim 1 including a cavity in the housing for engaging a fishing pole, the cavity adapted for securing the device to the fishing pole.

4. The fish hook holding device of claim 3 wherein the cavity of the housing is cylindrical.

5. A fish hook holding device mountable to a fishing pole, the holding device comprising:
a housing having a plurality of openings in the housing for insertion of a first end of a fishing hook, the housing mountable to a fishing pole or fishing pole accessory;
a plurality of first surfaces each surface disposed adjacent the corresponding opening and a plurality of second surfaces substantially perpendicular to the corresponding first surface; and
a spring having a plurality of spring segments adjacent the corresponding first surface, each spring segment urged against the corresponding first surface wherein a point end of a fishing hook may be inserted into the opening and secured between the corresponding spring segment and the housing first surface;
wherein upon insertion of a fish hook in at least one of the plurality of housing openings, a barb on the fish hook point engages the corresponding second surface, securing the hook in the at least one housing opening; and
wherein the hook may be removed by urging the hook toward the housing and pushed in a direction opposition the point to disengage the barb from the second surface.

6. The fish hook holding device of claim 5 including an upwardly angled lip at a terminal end of the first surface to secure the fish hook in the fish hook holding device.

7. The fish hook holding device of claim 6 including a cavity in the housing for engaging a fishing pole, the cavity adapted for securing the device to the fishing pole.

8. The fish hook holding device of claim 7 wherein the cavity of the housing is cylindrical.

9. A fish hook threading device comprising:
a housing fixed to a fishing pole, the housing defining a threader gap terminating in a first hook groove facing a first direction away from the housing, the housing having a first shoulder disposed proximate to the first hook groove, the first shoulder facing an opposite second direction;
a threader tip extending between a second shoulder proximate to a first end of the threader tip and a handle proximate to a second end of the threader tip, the second shoulder facing away from the first end towards a second hook groove disposed between the first end of the threader tip and the second end of the threader tip, and the second shoulder faces towards the housing;
a biasing member retained between the first shoulder and the second shoulder; and a sheath fixed to the housing, the sheath covering the threader gap of the housing,
wherein the biasing member acts against the first shoulder and the second shoulder to retain the threader tip in a closed state, a user exerts a force on the handle of the threader tip to displace the first hook groove relative to the second hook groove, and a force generated by the biasing member is sufficient to retain a hook between the first hook groove and the second hook groove when the threader tip is in the closed state.

10. The fish hook threading device of claim 9, wherein the force the user exerts is perpendicular to a fishing line placed therein.

11. The fish hook threading device of claim 9, wherein the threader tip further comprises one or more grooves forming an anvil for retaining a fishing hook and for directing a fishing line.

12. The fish hook threading device of claim 11, wherein at least one of the one or more grooves is a shank holder, the shank holder retains a shank of the fishing hook when the threader tip is in the closed state.

13. The fish hook threading device of claim 11, wherein at least one of the one or more grooves is an exit groove, the exit groove accommodates the fishing line that is threaded through the fishing hook retained by the threader tip.

14. The fish hook threading device of claim 11, wherein at least one of the one or more grooves is a threading groove, the threading groove accommodates an end of the fishing line and directs the end of the fishing line through an eye of the fishing hook retained by the threader tip.

15. The fish hook threading device of claim 14, wherein the threading groove is frustoconical in shape.
